(19) United States
(12) Patent Application Publication
(10) Pub. No.: US 2015/0199720 A1
(43) Pub. Date: Jul. 16, 2015

(54) System and method for targeted advertising and promotions using tabletop display devices

(71) Applicants: Wilbur Leslie Dublin, III, Austin, TX (US); Gregory Scott Fitzgerald, Austin, TX (US); Stuart Andrew Bell, Austin, TX (US); Brandon Carson Willard, Austin, TX (US)

(72) Inventors: Wilbur Leslie Dublin, III, Austin, TX (US); Gregory Scott Fitzgerald, Austin, TX (US); Stuart Andrew Bell, Austin, TX (US); Brandon Carson Willard, Austin, TX (US)

(73) Assignee: DISPLAY POINTS TECHNOLOGIES, INC., Treasure Island, FL (US)

(21) Appl. No.: 14/668,698

(22) Filed: Mar. 25, 2015

Related U.S. Application Data
(63) Continuation of application No. 13/999,473, filed on Feb. 28, 2014, now abandoned.
Application No. 13/999,473 is a continuation of application No. 13/598,610, filed on Aug. 29, 2012, now abandoned.
Application No. 13/598,610 is a division of application No. 12/183,862, filed on Jul. 31, 2008, now abandoned.
(60) Provisional application No. 60/953,222, filed on Aug. 1, 2007.

(51) Int. Cl. G06Q 30/02; G06F 3/0484

(52) U.S. Cl. CPC G06Q 30/0257; G06F 3/04842

(57) ABSTRACT

In one embodiment, a system includes a plurality of table-top display devices for displaying advertising content associated with advertiser to patrons of a business establishment. Each of the plurality of table-top display devices includes a display screen configured to display the advertising content, a data storage configured to store content data that defines the advertising or promotional content, and a control unit configured to access the content data in the data storage and control the display of the advertising content on the display screen. The display screen is a touchscreen display. The system also includes a server subsystem configured to allow user selection of the content data and to facilitate distribution of the content data to the plurality of table-top display devices. Distribution of the advertising content to the plurality of table-top display devices is at least partially managed by the advertiser.

### CROSS-REFERENCE TO RELATED APPLICATIONS

This application is a continuation of U.S. patent application Ser. No. 13/999,473, filed Feb. 28, 2014, which is a continuation of U.S. patent application Ser. No. 13/598,610, filed Aug. 29, 2012, which is a divisional of U.S. patent application Ser. No. 12/183,862, filed Jul. 31, 2008, which claims the benefit of U.S. Provisional Application No. 60/953,222, filed Aug. 1, 2007, all of which are hereby incorporated by reference.

### TECHNICAL FIELD

The present invention relates generally to the field of digital signage and a network for targeting, distributing, managing, and monitoring the performance of advertising and promotional content for distributed digital sign devices. The invention also relates to advertising, promotion, and informational services targeted at restaurant and bar patrons.

### SUMMARY

Various embodiments of systems, methods, and computer programs for maximizing the value of promotional and advertising content, delivered to tabletop displays in restaurants and bars are disclosed. In one embodiment, a system comprises multiple display devices that deliver digital advertising and promotional content directly to the tabletop of restaurant or bar patrons, along with a support server (typically located at each venue) that may be responsible for recharging batteries and/or replicating data files and managing communications. This server, in turn, may be linked by a conventional computer network or telephone data link to a content replication server that coordinates and directs placement of ads and other content on the display devices. The promotional, advertising, or other data may be made available to the distribution network from a network of one or more web application servers that may implement or be configured to perform a variety of methods or processes that not only provide for direct customer management and control of that data, but also contain a database of information help target, design, manage, measure and/or track the performance of advertisements and promotions based on a variety of criteria, including but not limited to geographical and/or demographic areas and venue-specific demographics (including those affected by meal, time-of-day, holidays, seasonal variations, community events, etc.). The web application servers may also be responsible for coordinating and managing patron responses from a variety of channels including direct interaction with the display devices (through buttons or a touchscreen, for instance), or indirect methods such as text messages, electronic mail messages, web pages, phone numbers, other response channels. In addition, the wan application servers may allow venue operators and/or third party advertisers to manage and control content through a web-based interface to create, upload, schedule, and/or direct advertisements and promotional content through the network.

### BRIEF DESCRIPTION OF THE DRAWINGS

FIG. 1 is a schematic illustration of a multi-level client-server communications architecture.

FIG. 2 is a schematic illustration of an embodiment of a tabletop display device.

FIG. 3 is a schematic illustration of an embodiment of a venue support server.

FIG. 4 is a diagram of possible interactivity mechanisms associated with the communications architecture of FIG. 1.

### REFERENCE NUMERALS IN DRAWINGS

100—Tabletop Display Device
110—Data interface
120—Computerized Control Unit
130—Power Input Circuitry
135—Battery
140—Data Storage
150—Display Screen
160—Internal Clock
170—Touchscreen Sensor
175—Card and/or RFID Reader
180—Input Buttons
190—Presence Sensor
195—Environmental Sensors
200—Venue Support Server
210—Data interface
220—Computerized Control Unit
230—Battery Charger or Power Supply
240—Data Storage
250—Network Interface
260—Power Input
300—Battery Charging or Power Connection
400—Data Connection
500—Network
600A, 600B, 600C, 600D—Network Connection
700—Content Replication Server
800—Data Storage
900—Web Application Server
1000—Web Browser

### DETAILED DESCRIPTION

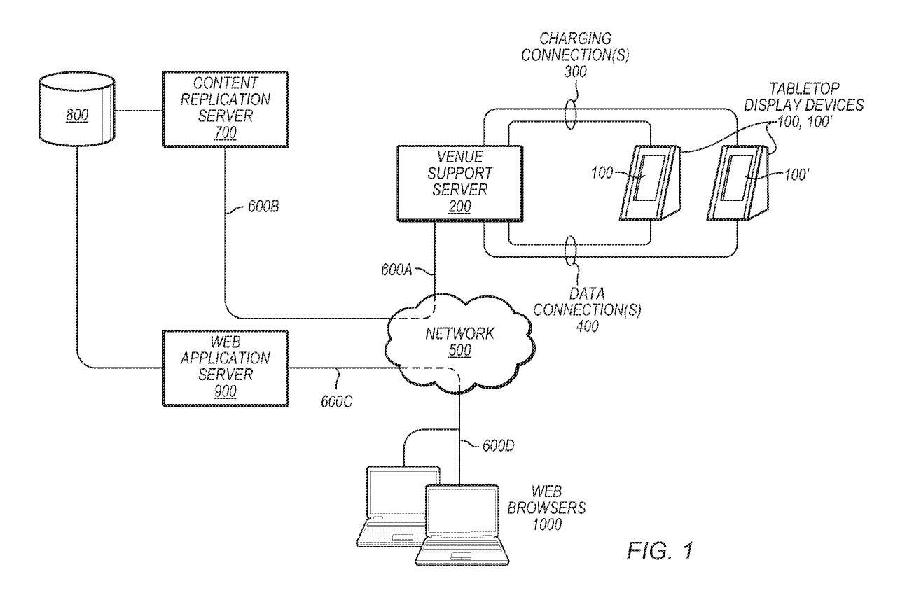

FIG. 1 is a schematic illustration of one embodiment of a system architecture diagram showing the various system components. Multiple Tabletop Display Devices (100, 100′) are illustrated that may be situated on restaurant and/or bar tabletops to display the desired advertising and promotional content and provide optional interaction with patrons at the venue of the restaurant or bar. If the logistics of the venue demand it, each Tabletop Display Device 100 may be connected intermittently or continuously to a Venue Support Server 200. This connection may include a Battery Charging or Power Connection 300, a Data Connection 400, or both. Each of these connections may either be conventional wired connections, or wireless embodiments of each type of connection, for instance, an inductive power connection for battery charging or a wireless data connection. The Battery Charging or Power Connection 300 and the Data Connection 400 may also be integrated into a single physical connection using well-known mechanisms, for instance, Universal Serial Bus (USB), 802.3af Power-over Ethernet (PoE), or others. Note that Data Connection 400 may be point-to-point or networked in nature, and if networked, may be implemented as a “mesh network” of wired and/or wireless network nodes to provide a path to the eventual destination. If Data. Connection 400 is implemented as an actual network (e.g., a Local Area Network, either physically, as in the case of Ethernet or 802.11 wireless, or logically, as in the case of point-to-point SLIP or PPP gateways to a remote internetwork), then Display Devices 100 may be directly connected to a network which may in turn be interconnected to Network 500 (typically a Wide Area Network such as an internetwork of leased or dial-up links or the public kite et) to allow communication with other Servers in the system. In such a situation, the functions of the Venue Support Server 200 may be relocated, for instance, with download management directly controlled by Content Replication Server 700 instead of relying on the services of a local Venue Support Server 200. The Venue Support Server 200 may be-connected to Network 500 (typically a standard interconnected network of networks such as an Internet TCP/IP network) via a Network Connection 600A. Content Replication Server 700 is also connected to Network 500 via Network Connection SOUP and has access to content stored in Data Storage 800. Web Application Server 900 is also typically connected to Network 500 via Network Connection 600C and has the ability to manage and control content stored in Data Storage 800. One or more Web Browsers 1000 are also connected to Network 50 via Network Connection 6000 to allow them to interact with Web Application Server 900. Note that depending on the exact embodiment chosen, some of these elements may be combined: for instance, if Tabletop Display Devices 100 are fully network capable, then venue Support Server 200. Content Replication Server 700 and Web Application Server 900 may be fully or partially combined at a remote site.

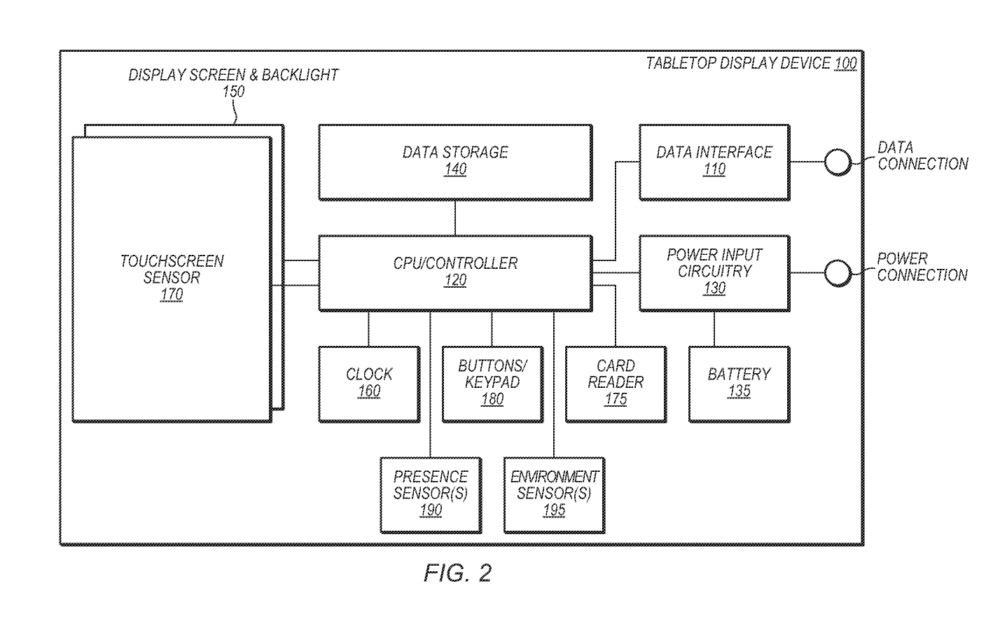

One possible embodiment of Tabletop Display Device 100 is shown in FIG. 2. Data interface 110 can connect to the corresponding Data interface 210 on Venue Support Server 200 via Data Connection 400. Data Interface 110 also connects to Computerized Control Unit 120, which runs computer program to perform appropriate control and communications actions for the entire Tabletop Display Device 100. Power Input Circuitry 130 can connect to the corresponding Battery Charger or Power Supply 230 of Venue Support Server 200 via Battery Charging or Power Connection 300 and internally to Battery 135, if present, and also to Computerized Control Unit 120 for monitoring battery and charging status. Computerized Control Unit 120 is connected to Data Storage 140, which may be one or more physical and/or logical data storage areas that contain the firmware and/or software programs for the Computerized Control Unit 120 itself, the code required to update that firmware code, replicated advertising and promotional content, control metadata, log and status information, and other information as required. Computerized Control Unit 120 and surrounding electronics may also be implemented directly in hardware using a variety of techniques including custom-masked chips, ASICs, FPGA, etc., or implemented using integration of multiple functions (such as Control Unit 120 and Data Storage 140) in a single chip or package. Data Storage 140 may be flash memory, but could also be implemented as any other suitable non-volatile memory such as magnetic or optical disk, EEPROM, FRAM, etc. The executable firmware and/or software programs of Computerized Control Unit 120 and the control metadata residing in Data Storage 140 determine bow to deliver the desired content to one or more screen units of Display Screen 150. Computerized Control Unit 120 may also be connected to Internal Clock 160 and optionally, any or all of Touchscreen Sensor 170, Card or RFID Reader 175, input Buttons 180, Presence Sensor 190, and Environmental Sensors 195.

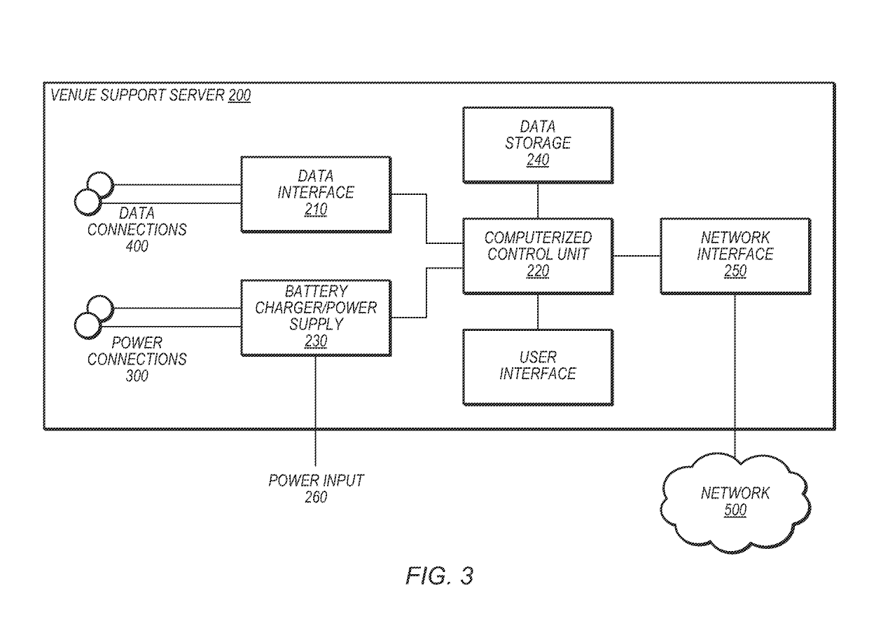

FIG. 3 illustrates one possible embodiment for the subsystems of the Venue Support Server 200. Typically, each Venue will have a Venue Support Server 200, which may support from a few to a few dozen or more Tabletop Display Devices 100. One or more Data Interface (s) 210 can connect to one or more corresponding Data Interface(s) 110 on the Display Device 100. Data Interface 210 connects to a Computerized Control Unit 220, which can run a stored computer program directing the operations of Venue Support Server 200. Data interface 210 may be point-to-point or networked, and may in fact be a full-fledged network such as a Local or Wide Area TCP/IP Network. Likewise, one or more Battery Charger or Power Supply 230 can connect to one or more Power Input Circuitry 130 connections Tabletop Display Device 100 via Battery Charging or Power Connection 300 in order to provide operational power or to recharge optional onboard Battery 135 of the Tabletop Display Device 100. As described above, of course, the Battery Charging and Power Connection 300 and the Data Connection 400 and their associated interfaces may be integrated into a single combined power and data connection using either proprietary mechanisms or standard mechanisms such as USB, Firewire, or powered Ethernet. The Computerized Control Unit 220 is also connected to Data Storage 240, which like the Tabletop Display device, may be one or more physical and/or logical data storage areas that contain executable firmware and/or software program code for the Computerized Control Unit 220 itself, the code required to update that firmware and/or software code, replicated advertising and promotional content, control metadata, log and status information, and other information as required. Data Storage 240 may be flash memory, but could also be implemented as any other suitable non-volatile memory such as magnetic or optical disk, EEPROM, FRAM, etc. Computerized Control Unit 220 is also connected to Network Interface 250, which may connect to Network 500 via Network Connection 600A and may a conventional TCP/IP Local Area Network (LAN) connection such as Ethernet or 802.11 wireless, although any similarly capable network is viable as a substitute.

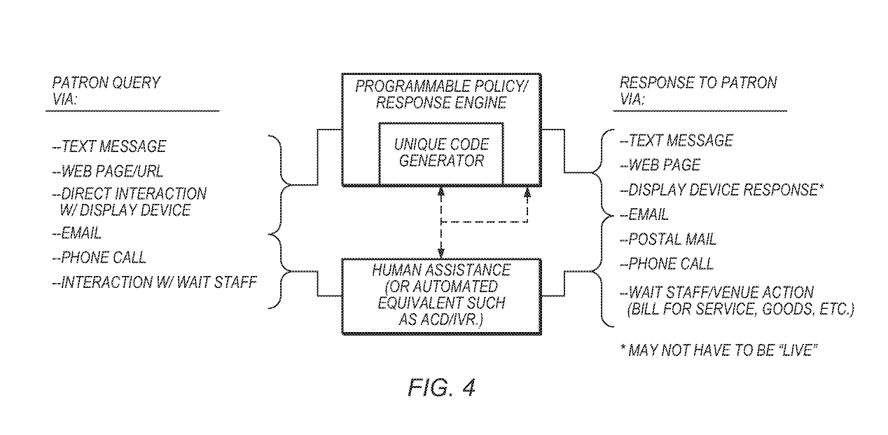

FIG. 4 illustrates some of the potential pathways for interactivity with venue patrons, showing various methods for patrons to submit queries or requests, and the various methods by which responses may be delivered. Note that both “in-band” and “out-of-band” methods are available for both queries and responses. Also, some of the interactivity methods may require human interaction. Note also that even interactive responses from the Tabletop Display Device itself do not necessarily require a “live” data connection—for instance, some types of interactivity, such as delivery of a unique coupon or offer code, may be performed entirely by the Tabletop Display Device 100 itself, negating the need for a live network even to support direct interactivity with the display device itself.

The system illustrated in FIG. 1 may be designed to deliver targeted advertising and promotions to a variety of locations, but primarily locations such as tabletops or countertops at restaurants, bars, and clubs or waiting areas where people may congregate and be present for a period of time significant, enough to be a valid audience for advertising and promotional messages.

Tabletop Display Device 100

The primary delivery channel for such messages is the Tabletop Display Device 100, which is a digital display device designed for use in or on tabletops of restaurant and bar venues. In other embodiments, a Display Device with similar capabilities may be used which does not necessarily have to be on, in, or even designed as a tabletop unit—for instance, it may be implemented as a wall or door-mounted unit (the former might be useful for restroom advertising in any kind of venue, the latter to keep restaurant wait staff informed of specials and dish availability as they move in and out of the kitchen), at bar counters, host/hostess stands, waiting areas, or at other appropriate locations at a suitable venue. If used as a discrete tabletop unit, then the Tabletop Display Device may be integrated with or contained by a receptacle for tabletop condiments such as salt, pepper, sweeteners, sauces, etc. The Tabletop Display Device and/or the receptacle may also be mounted on a motorized or non-motorized “lazy susan” type of turntable bearing allowing the device to be more easily viewed from various points around or nearby the table.

The Display Screen 150 portion of the Tabletop Display Device 100 itself can be any type of appropriate computer-controlled display technology—including but not limited to LCD (reflective, transmissive, or transflective), LED/OLED, plasma, or displays such as e-ink, or electrowetting displays. The Tabletop Display Device may contain multiple display screens and/or display images. One way this may be done inexpensively (from both device cost and power budget perspectives) is to produce a Display Screen 150 that may sandwich a backlight assembly (using a variety of backlight technologies, such as LED or CCFL) between two conventional LCD or other appropriate displays requiring backlighting. The two displays may be independently controlled, or they may use shared control lines so that they appear as a single display to the rest of the system, thus presenting an identical image on either side of such a two-sided display unit. In other embodiments, multiple display screen units may be used to provide for three or more displays in a particular Tabletop Display Device 100 to extend the field of view. If the display is light-emitting, the Computerized Control Unit. 120 present in each Tabletop Display Device 100 may optionally control the brightness of the Display Screen 150 based on any combination of clock time, time window (an interval in time, possibly recurring), ambient light levels, or brightness of the content in order to maintain the proper ambience and atmosphere of the restaurant or bar venue's environment.

The Tabletop Display Device 100 may be self-contained (including power supply such as a Battery 135), but it may alternatively rely on external resources for power and/or data. Typically, Tabletop Display Devices 100, 100 will be either self-contained and battery-powered, or tethered by an external power and/or data connection, for example, 802.3af Power-over-Ethernet, which provides in a single unified connection both Battery Charging and Power Connection 300 as well as Data Connection 400. Other arrangements are possible as well, for instance, a self-contained battery-powered unit (with an optional Battery Charging and Power Connection 300) that embodies Data Connection 400 as a wireless data connection for content replication and/or interaction communications with the patrons at the restaurant/bar venue. For suitably low-power Display Screens 150, power for the Tabletop Display Device 100 may also be locally generated (e.g.: by solar cells or fuel cell generators powered by methanol, propane, hydrogen, or other appropriate fuels) and optionally stored in local energy storage systems (e.g.: batteries or large capacitors, which may be removable and replaceable for convenience). If the displays are self-contained, the content they contain may be updated over a Data Connection 400 either by continuous or intermittent connections to a communications station (which may be integrated with a battery charging unit) or alternatively, by a wireless data link. In either case, the content may be replicated and distributed using proprietary methods or well-known standard techniques such as distributed file synchronization (e.g.: rdist, Unison, SyncToy, scripted FTP or file copy, etc.), version and/or revision control systems (e.g.: RCS, CVS, Subversion, etc.), or by a store and forward delivery system (e.g.: e-mail or uucp). Depending on the behavior desired, this content synchronization may be triggered and managed by an “upstream” computer or controller (e.g.: the Venue Support Server 200 and/or Content Replication Server 700) or by the Tabletop Display Device 100 itself that is, the data transfer may be “push”, “pull”, or a combination of both. Note that the direction of information flow does not necessarily have to be “downstream” toward the Tabletop Display Device 100. One example of this might have the device collecting an auditable log of patron presence, interactive usage, display statistics, and other information that could be transferred “upstream”, while also allowing new content and control metadata instructions to flow “downstream” either simultaneously or interleaved with the upstream transmission, depending on whether full or half-duplex communications are available.

In addition to the Display Screen 150 itself, the Tabletop Display Device 100 contains a Computerized. Control Unit 120. This Computerized Control Unit 120 has access to Data Storage 140, which may or may not be logically and/or physically divided to contain the executable software code and/or other programs for the Tabletop Display Device 100 itself (which may also include executable programs for updating said software and/or firmware). Data Storage 140 may also provide storage for the actual advertising or promotional content and control metadata data about how and when that content data should be delivered through the device's display and optionally housekeeping information such a unique Unit ID and “health and status” information that may be used and analyzed for a variety of purposes. In a typical configuration, the Data Storage 140 for advertising and promotional content may include the various content elements themselves along with control metadata. This control metadata (which may vary from a simple “play list” of sequenced content identifiers to complex programmable presentations dependent on a variety of internal or external variables) defines when and how the Tabletop Display Device 100 should present the content elements. For example, the control metadata might include a schedule determining which advertisements and promotions are set to run during a pre-defined time window, but may also encompass more complex behavior such as “if new patrons have not already been sensed in the past fifteen minutes (to avoid false triggering by up-and down re-seating or returns from the restroom, etc.) then display a specific advertisement for twenty-five seconds after detecting newly seated patrons, switch to content related to specials, and change the default update interval, to 15 seconds”. The control metadata may be a text or binary representation, but will typically be a tag-structured text format such as Extensible Markup Language (XML) or a directly interpretable data format such as JavaScript Object Notation (JSON).

The content elements may be comprised of or include (but are not limited to):

1) images in either bitmap (e.g.: JPG, PNG, GIF, etc.) or vector (e.g.: SVG, Flash, NAPLPS, etc.) form,

2) web pages or other display markup (e.g.: HTML/CSS, XHTML/XSL, PDF, etc.), or

3) moving images (e.g.: Animated GIF, Flash, MPEG, WMV, Quicktime, MNG, etc.) and/or audio (e.g. MP3, ACC, WAY, etc.). Moving images may optionally include audio, which is primarily useful in settings other than those that are the primary target for the invention, since audio is generally undesirable in those settings.

In addition, the Tabletop Display Device 100 may contain an Internal Clock 160 that can be used along with the control metadata residing in Data Storage 140 to trigger a set of actions at a particular time. A typical example of this might be a set of control metadata to switch from content appropriate for Breakfast to that appropriate for Lunch at a specific single point, in time, or alternatively, to phase in the content from Breakfast to Lunch over a period of time. Such control metadata may also be responsible for determining appropriate advertising or promotional content based on a variety of other criteria that may or may not be related to time, such as (but not limited to) number of views or impressions, weather or other external data, environmental information such as temperature/humidity, ambient lighting, presence and number of patrons, direct patron interaction, etc.

A further potential use of the Internal Clock 160, if made sufficiently accurate, is to synchronize and/or coordinate the changes in content across multiple Tabletop Display Units (100, 100) in a particular room or venue, to avoid the “Vegas effect” of many such displays changing in a haphazard fashion. Managing screen transitions in this way may be important in maintaining the desired “atmosphere” of a restaurant or bar venue, especially if the display screen technology in use emits light. Such screen transition management may even involve coordinated schemes where the mix of “light” and “dark” screen images at a given time may be controlled and coordinated with the style and type of image transition (e.g.: fade/fade rate, direct cut, or animated transition effect) to ensure the average light intensity of the Tabletop Display Devices is maintained within a desired range across a room or venue. Such brightness coordination schemes might rely on pre-programmed schedules, or adaptive systems based on ambient light, measurements, or possibly even dynamic communications with other Tabletop Display Devices (100, 100′) at the venue, either directly or through a central venue controller such as the Venue Support Server 200. In such a system, the effective luminosity of each promotional or ad screen image may be pre-computed by an upstream server and distributed as part of the metadata or computed locally after the content has been replicated the Tabletop Display Device 100. Either cooperative scheduling or dynamic interaction between units (either in real time, or pre-negotiated through an intermediary system such as the Venue Support Server 200) can then be used to ensure the average intensity level in a room stays roughly the same. A similar result can be achieved by pre-computing a rotation schedule for each device that allows the average brightness to remain relatively static far all devices in the room by offsetting a bright image on one device with a dark one on a neighboring device.

The Tabletop Display Device 100 may also optionally include a number of inputs, for interactive response by patrons and/or for sensing of the local environment. Interactive capability may be provided by means of a touch sensing capability for the display screen itself (Touchscreen Sensor 170), or input Buttons 180 such as a keyboard or keypad, individual function buttons, or “touch-pad” areas (for instance a button to call the waiter or waitress) on the device, or a combination of the above.

Environmental sensing capability may be provided by Environmental Sensors 195 using simple sensors such as an ambient light sensor (which can be used to adjust the display intensity if the display technology employed emits light), or more complex sensors including a Presence Sensor 190 to measure or indicate the presence of a suitable human audience. Technologies for the Presence Sensor 190 may range from passive systems like simple passive infrared motion sensing to complex image processing systems such as shape or object recognition based on still or moving images from one or more embedded cameras. In the latter case, such image processing capabilities may include the ability to determine a count of the number of people present at the table as well as other possible demographic information such as approximate age and sex.

Further interactivity may optionally be provided with personal electronic devices such as wireless phones or PDAs or even, with other Tabletop Display Devices through means such as “beaming” of contact, calendar, or other data over passive or directed infrared data links (such as those commonly used by modern PDAs and computers), or point-to-point or networked data communications or transfer is other means such as Bluetooth, ZigBee, WiFi, or proprietary wireless data links. The latter sort of point-to-point communications links may be used to establish a “mesh network” which allows “live” or interactive traffic to hop through multiple Tabletop Display Devices en route to a gateway or other eventual destination. Note that Data interface 110 may allow more than one communications method, and that each of these physical network layers may conceivably be used for multiple purposes to communicate with both the rest of the network comprising the disclosed system and/or with other external devices such as personal electronic devices.

The Tabletop Display Device 100 may also facilitate interactivity with wait staff and/or other systems at the venue, from mechanisms as simple as a “call button” to summon a server, to touchscreen menus to place think, food or dessert orders, to a “remote checkout” system that would allow the patron to settle his bill electronically and securely eliminating the need to wait for the server to provide this service. The call button function, for instance, could be as simple as activating an “attention needed” light (similar to those used on airliners) located at the top of the Tabletop Display Device, or as complex as a wireless signal to a server at the venue that relays a message to contact the server via a notification such as display on a device such as a pager, phone, PDA, or electronic order-entry device. To enable the remote checkout function, the Tabletop Display Device 100 may optionally contain an electronic Card and/or REID Reader 175 to collect payment information (e.g.: from a credit or debit card) and settle the bill at the table. The software running on the Computerized Control Unit 120 of a device so equipped could allow easy splitting of checks in large parties, something that is so troublesome, error-prone, and time consuming with conventional methods that many restaurants and bars decline to do it in the case where the Tabletop Display Device 100 allows a high degree of live interactivity, individual patrons in the party may be able to or drinks, appetizers, or even their meal using the device, and they could later easily select the items that were theirs from the table check, add a tip, and settle the bill instantly using electronic payment such as a credit or debit card (or alternatively by leaving the indicated amount of cash behind). Electronic credit or debit transactions may be securely encrypted by the Tabletop Display Device 100 and communicated back to the Venue Support Server 200 or to some other interface to the venues point-of-sale computer system or a third-party point-of-sale transaction system via a wired or wireless network link.

The executable software code stored in Data Storage 140 and running in the Computerized Control Unit 120 of the Tabletop Display Device 100 may also provide entertainment and information to patrons, for instance trivia questions or brainteaser games that might help wait time sass faster. These games and diversions may or may not be interactive depending on the capabilities of the particular Tabletop Display Device 100. In addition, the Tabletop Display Device 100 may show a live or stored feed of general interest information such as weather, news, or sports scores for the same purpose. These features may also be sponsored by advertisers and have sponsorship frames or linked advertising content associated with them in devices capable of interactivity. Note that interactivity for these entertainment and information features may be provided using not only in-band “live” communications, but also any of the out-of-band methods that can be used to respond to advertisements and promotions, including those shown in FIG. 4.

Further, the user interface of the Tabletop Display Device 100 might offer various types of interactive capabilities, for example, it might allow the patron to navigate backwards and forwards through the sequence of advertisements and promotions, or allow the patron to lump directly to a particular advertisement or promotion of interest from an index page or other navigation aid. Further, it might contain a kind of web browser (controlled by touchscreen or keypad controls) that allows the patron to “drill down” into ads or promotions of interest, for further information or interaction. (Note that such “drill down” navigation, to local “captive” web pages does not necessarily require a live communications connection, since the captive pages could be preloaded into the Data Storage 140 built into the Tabletop Display Device 100.) As an example scenario, if a patron finds the low-carb chocolate dessert special appealing (and the promotion just vanished off the screen to be replaced by another), she could begin the process by simply touching the screen, which would then overlay the current advertising or promotional image with appropriate navigation and other controls, perhaps labeled textually and/or graphically as follows:

“Bank” or “Previous”,

“More Info on this” (f more into indeed exists),

“Next” or “Forward”, and possibly

“Index” or “Up” (again, if available), and

Other Controls as Appropriate

The patron then selects “Back” to go back to the yummy chocolate dessert (or perhaps alternatively selects “Dessert Menu” from a higher-level screen and then navigates to the dessert from there), then selects “More Info on this” to learn more about it. She's in luck—the restaurant has entered nutrition information into the system, so she selects “Nutrition Info”, and after making sure the dessert does not contain aspartame (which gives her convulsions), selects “Order this dessert now”. She may be further prompted and respond as to the quantity and whether or not other dessert items are wanted at the table, then she might select “Place Order” at which point her order information might be transmitted to a venue server such as Venue Support Server 200 which in turn might enter the order into the restaurant's existing order—tracking system, with the order already assigned to the server on duty for that table. Moments later, the kitchen has prepared and the server delivers a warm bowl of Chocolate Goo DeLite to the happy patron. The venue server (such as Venue Support Server 200) might then log the transaction as a successful up-sell and record statistical information that may be useful in the future for other similar promotions.

In similar fashion, the same capabilities could be used by patrons to learn more about a third-party ad unrelated to the restaurant or its systems, for instance, an ad from a local car dealer about a special on a particular car could let the patron use the “More Info” function to find out more about the features and available deals a particular vehicle, and might even transfer contact information for whom to speak with a the dealership to the patron's “to-do” list, calendar, and/or contact list using standard infrared “beaming”, wireless communications such as Bluetooth, or “Web 2.0” interfaces such as online task management, address book, or calendar servers.

Note that such interactivity may not require any hardware input capability at all (such as Touchscreen Sensor 170 or input Buttons 180) in some embodiments of the Tabletop Display Device 100. For instance, in an embodiment such as one in which Tabletop Display Device 100 may not include interactive input hardware, a similar dessert promotion might ask the patron to do any of the following things to follow up on a promotional special using methods including but not limited to those shown in FIG. 4:

1) Interact directly with the server to say you saw the ad on the device,

2) send a specific text message to a specific number or “short code” to receive back a response (such as a “coupon code” (that may be validated and/or used only once to avoid abuse),

3) call a phone number answered by a call center to handle the transaction and response,

4) visit a specific web URL to receive the response (this mostly limits the system to patrons that have wireless phones with web browsers, but those are increasingly common),

5) or other similar response method that does not require the interactive channel to exist within the Tabletop Display Device, itself.

The Computerized Control Unit 120 in the Tabletop Display Device 100 may also run executable software code residing in Data Storage 140 (or possibly in other auxiliary data storage) to deter theft and attempted modification of the Tabletop Display Device 100 itself. Such software may require periodic communication with another system that can provide proper cryptographic or other authentication. In one embodiment of such software, if the Computerized Control Unit 120 of the Tabletop Display Device 100 is not able to verify that it is still in routine contact with an authorized network after a period of time, or if the device detects that it is being probed in an unusual way, then the system may take actions intended to make the device worthless to casual thieves and/or “hackers”. Such actions may include modifying or obliterating firmware and/or software programming; rerouting, redefining, or fusing vital, hardware connections; and/or simply displaying a message to announce that the unit has been stolen and disabled. In an embodiment in which a stolen Tabletop Display Device has built—in network capability such as Ethernet or a common wireless network such as the 802.11 family, attempts to connect and communicate with the device on an unauthorized network might result in the anti-theft/anti-tamper software residing in the device sending out an “I'm lost” message to a known fixed address. Such a message (which may take a form designed to make it less conspicuous and more likely to traverse intermediate systems such as firewalls, might be fashioned as a special “ping” packet, Syslog message, or DNS or web URL request, for example) may provide adequate information to allow authorities to track the location and identity of the thief.

In another embodiment, the executable software programs running in the Computerized Control Unit 120 in conjunction with the control metadata replicated to it may at times instruct the Tabletop Display Device 100 or the Venue Support Server 200 to modify content templates or skeletons with locally generated content. For instance, in an embodiment in which a Tabletop Display Device 100 has interactive capabilities, a particular promotion may direct the patron to enter their e-mail address or phone number in order to receive a discount coupon code or offer code and possibly opt-in to periodic notifications of specials. In order to prevent abuse such as reusing codes or guessing the next valid codes, such codes should random or pseudo-random. In an embodiment in which direct interactivity is possible, the software running in Computerized Control Unit 120 in the Tabletop Display Device 100 may be responsible for generating a valid code locally for use by the patron. Templates to deliver custom content such as these sorts of one-time codes may be made up of a basic skeleton of content with associated markup HTML/CSS, XML, SVG, wikcode, web application server variable substitution code, etc.) to indicate where and how the generated content should be inserted, and optionally, instructions on how to actually generate the content in question. Another example of this type of overlay might be to display content pages for the presentation of periodically updated data such as news, weather, sports scores, trivia questions, etc. The data to be overlaid may come from sources upstream in the network (e.g.: an RSS/XML feed of weather forecasts or news items) and may either be “live” if the Tabletop Display Device 100 in question has direct access to a network or it may have been stored in Data Storage 140 at the most recent replication event. Less frequent updating (via nightly replication, for instance) is adequate in most cases for more slowly changing information such as weather and trivia, but may be less than optimal for more timely information such as news and sports scores.

Supporting Network and Servers

Although Tabletop Display Devices 100, 100′ are a very visible part of the comprehensive advertising and promotions management system described, a variety of other servers and network components may exist at various locations to support and add value to the Tabletop Display Units located at each venue.

Venue Support. Server(s) 200

For example, in some embodiments in which the Tabletop Display Devices are self-contained and may require external support for battery charging and content replication management, then a Venue Support Server 200 may accordingly be provided with capabilities to manage and replicate promotional and advertising content as well as additional content for control systems, asset management, and other housekeeping functions. In the case of more advanced Tabletop Display Devices embodiments that may have more intelligence and more built-in network/communications capability, (and perhaps optionally, even on-board charging circuitry) the Venue Support Server 200 may be little more than a powered 802.3af Ethernet switch, which provides power for each Tabletop Display Device to charge its own batteries, while also letting each device make its own independent connection back to a remote server with which it can replicate and synchronize both promotional and advertising content as well as a variety of information, required to manage, maintain, and support the device in the field.

The precise functional boundaries in each of the server elements may vary upon the implementation. The server functions may be implemented in a number of ways in differing embodiments, for instance, responsibility for content replication and management may be entirely centralized to a central server, entirely distributed to the end nodes themselves, or split with one or more middle tiers sharing appropriate portions of the workload.

In a typical implementation, the Venue Support Server 200 might include multiple subsystems, for example, to provide and manage battery charging, and also to manage content replication both upstream and downstream, and optionally, provide a central control panel for managing all the Tabletop Display Devices at a particular venue. Such a Venue Support Server 200 contain its own Computerized Control Unit 220 to facilitate such operations, directed by executable software code residing in Data Storage 240 that could provide the desired functionality, including but not limited to the following capabilities: For asset management and inventory control, the Venue Support Server 200 software may maintain a log of “in” and “out” timestamps for each Tabletop Display Device 100 as it is connected to and disconnected from the Venue Support Server 200. Such a server might also use its Data Storage 240 as a buffer for intermediate storage of advertising and promotional content as well as control metadata and policy setting information. The Venue Support Server 200 may also be responsible for periodically checking in with the central Content Replication Server 700 to determine if updates are available, and if so, replicating new data to local Data. Storage 240 for later downstream replication to each Tabletop Display Device 100. Such updates may be initiated by the establishment of a suitable data connection (such as plugging the Tabletop Display Device into the Venue Support Server) if wired or short-range wireless, but may also triggered by an elapsed time interval or other manual or automatic activation methods for either wired or longer-range wireless use. The Venue Support Server 200's software might also be responsible for collecting, maintaining, and/or propagating upstream a log of telemetric information about itself and each Tabletop Display Device 100, that might include, but not be limited to

1) Information about battery charging (such as voltage and current levels, battery temperatures, charge status, battery life statistics such as run time before power ran down, and overall battery wear status);

2) Information about memory use, memory errors or “wear” for flash, and status of loaded programs, firmware, content, and metadata, success and/or failure of replication attempts and a log thereof;

3) information about patron presence monitoring (patron presence/absence event timestamps, number of patrons present at table, and if appropriate sensor data is available, perhaps even sex and age of patrons);

4) Information about patron interactivity with the Tabletop Display Device 100 (log of interactive events such as server calls (and subsequent resets for monitoring response/wait times), page views (including navigation through advertisements and promotional content as well as menus and information about restaurant or bar specials, as well as time-stamped view information for “captive pages” that patrons may navigate through to “drill down” to get more information about any of the above);

5) Verification that promotional and advertising content, metadata, programs, and other data reported by the Tabletop Display Device is indeed correct and up-to-date, flagging any areas that need attention.

Back-End and Web Application Servers

Several other back-end server functions to provide additional, value to advertising customers and venue operators may be provided by one or more servers, with the exact number and arrangement being dependent on cost, robustness/reliability/failover, ease of database and application configuration and maintenance, scalability, security, and other parameters. Although the exact numbers and division of labor amongst servers may vary depending upon the implementation, this description will refer to each functional area as though it was implemented on a single server, even though it is understood that the number of servers actually employed is variable depending on system architecture.

One primary function is the delivery of appropriate advertising and promotional content, control metadata, and other information to the end nodes, typically Tabletop Display Devices 100, 100′. The Content Replication Server 700 may be configured to coordinate and/or facilitate this functionality, which in essence ensures that the correct content is delivered to the correct destination. Content replication may be initiated in either a “push” or “pull” fashion (or a combination of both), using well-known mechanisms for distributed content synchronization, such as, but not limited to techniques such as distributed synchronization (e.g.: rdist, Unison, SyncToy, scripted or file copy, etc.), a version and revision control system (e.g.: RCS, CVS, Subversion, etc.), or by a store and forward delivery system (e.g.: e-mail or uucp). Depending on the behavior desired and the capabilities of the devices involved, this content synchronization may be triggered and managed by an “upstream” computer such as the Content Replication Server 700 or the Venue Support. Server 200, or directly by the Tabletop Display Device 100 itself. For example, in an embodiment implementing “push” replication, the replication process may be initiated by Content Replication Server 700, while in an embodiment implementing “push” replication, the process may be initiated by Tabletop Display Devices 100, 100′. Many hybrid push/pull embodiments are also possible, for instance, one in which the Venue Support. Server 200 initiates replication with the upstream Content Replication Server 700 using a “pull”, and then “pushes” that content downstream to the Tabletop Display Devices 100, 100′. In other embodiments it is noted that the Venue Support. Server 200 might be responsible for the primary coordination role, periodically checking with the Content. Replication. Server 700 to see if there is new content to be distributed to any of the Tabletop Display Devices (100, 100′) for which it is responsible. If new or updated content is present, then the Venue Support Server 200 may replicate the content (e.g.: using one of the methods described above) destined for each device either directly to the attached Tabletop Display Device 100, or optionally, to a local storage cache for later replication to the Tabletop Display Devices 100, 100′ themselves. Note that each Tabletop Display Device 100 may have different content—for instance, each tabletop may have a unique response code in the text message response prompt for a particular promotion, such a unique code could identify which Tabletop Display Device began the transaction. Alternatively, identical content may be shared by entire venues, or even across venues, or content for venues may be split in any way desired, for instance by waiter/waitress areas, table/booth, interior/window, restaurant/bar, etc.

In addition, the content may contain markup or other instructions that allow insertion or overlay of locally generated content into the replicated content structure—for instance, to achieve the same unique code per tabletop as the previous example, but without having to resort to distributing different content to each unit, a generic ad may contain markup for a locally generated code based on the Unique ID of the Tabletop Display Device to be overlaid on or integrated into the downloaded advertising or promotional content in this way, each display unit could have a unique response code without the trouble and associated expense associated with having to create and manage unique versions of the content for each destination Tabletop Display Device unit. Such markup or overlay of graphics and/or text could be provided in a number of standard or proprietary ways, including HTML/CSS, Adobe Flash, on-the fly creation via Javascript, etc. Such methods might also be appropriate to “customize” generic promotional templates with information specific to an arbitrary set of venues or subsets thereof in an arbitrary set of potential Tabletop Display Devices, based on a arbitrary set of geographic, venue, demographic, or other criteria. In varying embodiments it is noted that the overlay or integration of such graphical or text elements with a generic “skeleton” or “template” may occur at any one or more of several points in the process: For instance it may occur at a central server (for instance the Content Replication Server 700), with differing content then replicated to the Tabletop Display Devices (100, 100′), it may occur at an intermediate server such as the Venue Support Server 200 (where a single template or skeleton might be modified or overlaid with site-specific information or even end-node (Tabletop Display Device) specific information), it may occur at the end node Tabletop Display Device 100 itself, with unique modifications for each end node. In all cases, the scope and effect of the customizations of such skeleton or template-based content may determined by the accompanying control metadata, and may be based on an arbitrary set of parameters such as but not limited to any mix of venue (including type, location, or ownership), promotional partner, time/date, geographical location, demographic selection, local events, or other criteria is further noted that the source of data which is to be overlaid or integrated need not be static, but might be a continuous or continual data feed, for instance, weather, news, sports scores, market data, breaking/emergency news and alerts, Amber alerts or Homeland Security alerts, etc. In various embodiments, the sources of such data may be either “in-band” or “out-of-band”, for instance, an RSS/XML news feed accessible to any networked component of the system, or a radio paging receiver for weather and news headlines.

In a typical embodiment, the Content. Replication Server 700 itself may receive the content to distribute via either push or pull, from a Web Application Server 900 designed for use by a variety of interested parties, including but not limited to venue owners/operators, advertisers and promoters, patrons seeking follow-up (for instance to look up an ad they saw on a Tabletop Display Device on a recent restaurant visit etc.

From the point of view of the operator of a restaurant or bar venue, the Web Application Server 900 software may configured to perform a variety of functions including but not limited to one or more of the following:

1) Define, manage, and edit time windows that, may control the timing and rotation of advertising and promotional content, both internal and external or third-party (for instance, defining time windows for breakfast, lunch, happy hour, and dinner note that in and external, time window definitions may conceivably differ);

2) Define, manage, and edit a recurring, repetition of such time windows (allowing, for instance, one set of time windows for Monday through Thursday, another for Friday and Saturday, and yet another for Sunday) or time windows that reflect events on a longer schedule, for instance holidays or important local events such as festivals, conferences, or meetings (significantly important events (e.g.: Easter or Mother's Day) may also be entered by the network administrators and made available to all users, avoiding the need to have these needlessly re-defined);

3) Easily create, manage, and monitor the venue's own internal advertisements and promotions to be deployed through the network, in one embodiment this includes a “holding area” allow easy re-use of advertising and promotional content that may have been previously uploaded to the system but is not presently running;

4) Select and/or preview advertisements and promotions scheduled for or available to that venue and optionally approve or reject them (such review and or approval/rejection might be either individually or by category, for instance reject all beer advertisements for a venue that does not serve alcohol, or reject ads for a particular beer brand not served, at that venue);

5) Provide dashboard or control panel to manage the rollout and release of various advertisements and promotions for campaigns at or across venues for which the user has been granted control;

6) Measure and monitor the effectiveness of promotions using a “Promo Advisor/Optimizer” to compare alternative and/or previous promotions, compare results with (suitably privacy-masked) comparable or neighboring venues, track and calculate Return-On-Investment for promotions/advertisements, report statistics related to ticket size increase/decrease or offer uptake, and generate suggested specials based on knowledge accumulated from the entire network, generate proposed promotions plans based on accumulated knowledge from prior and current performance;

7) Measure and monitor the performance of interactive feedback to advertisements and promotions (this may be direct interactivity through suitable Tabletop Display Devices (either live or store-and-forward)), or indirect interactivity through means including, but not limited to text messages, electronic mail, phone calls, web sites, etc.

8) Manually initiate a refresh of the content on one or more of the Tabletop Display Units for that venue;

9) If the restaurant or bar's menu is to be made available for viewing and/or ordering from the Tabletop Display Device, enter and maintain menu information such as item names, descriptions, prices, photos and/or videos, and nutritional or other information,

10) Manage appropriate connections and data sharing with the venue's various computer systems (e.g.: point-of-sale, transaction processing, order entry, etc.),

11) Apply settings and policy hierarchically across an organization, greatly reducing the effort required to manage and configure multiple venues such as a chain of restaurants.

From the point of view of a customer wishing to deploy an advertisement or promotion into the network, the Web Application. Server 900 software may be configured to perform a variety of functions including but not limited to one or more of the following:

1) Target advertisements or promotions by geographical location (such as code, region of city, distance (radius) rom a given location, travel time/distance from a given location, etc.);

2) Target advertisements or promotions by demographics (for instance, single professional females 25-35 may be most reachable by lunch advertising at one set of venues, happy hour at another set of venues, and dinner at yet a third set);

3) Target advertisements or promotions based on time, including time-of-day, time-of-week, time of month/year, holidays and/or religious or cultural events (Christmas, Fourth of July, Mother's Day, St. Patrick's etc.), or local events (festivals, conferences, meetings, sports events, etc.);

4) Provide a dashboard or control panel to manage the rollout and release of various advertisements and promotions for campaigns, for instance, manage the deployment of a particular advertisement for branding in a particular region, while scheduling the release of a promotion to coincide with an upcoming event.

5) Purchase “distribution slots” online for the advertisement, or promotion to achieve the desired number of impressions to the desired demographic audience, possibly after using the system to identify the appropriate placement.

6) Make advertisements and/or promotional content available to venues for them to select and authorize for deployment at their venues.

7) Upload artwork or other content to the network for approval and release.

8) Measure and monitor the effectiveness of promotions using a “Promo Advisor/Optimizer” to compare alternative/previous promotions, compare applicable results statistics across venues, track and calculate Return-On-Investment for promotions/advertisements, generate suggested promotions based on knowledge accumulated from the entire network, and/or generate proposed promotions plans based on accumulated knowledge from prior and cumin performance;

9) Measure and monitor the performance of interactive feedback to advertisements and promotions (this may be direct interactivity through suitable Tabletop Display Devices (either live or store-and-forward)), or indirect interactivity through means including, but not limited to text messages, electronic mail, phone calls web sites, etc.

The user interface to such a system may include several views that mix geographic and demographic information in useful ways. One view might be mostly geographical in nature a dynamically updated map showing available venue locations along with patron and local area demographics, and perhaps as a set of concentric rings radiating out from the venue or another local point of interest representing corresponding demographic regions. For instance, an advertiser might want to target the attendees of a conference, centering the view on the hosting hotel by clicking its location on the map. The map display would show available venues within, say, a one-, two-, or three-mile radius, along with summaries of the demographics for each concentric circle and detailed patron demographics for each of the available venues shown. Another view might be more demographically oriented. In this case the advertiser might be interested in targeting a specific group (such as mothers of young children with a particular family income located in any of three adjacent zip codes) for a branding campaign for a local children's clothing business. The desired demographic is selected first, and then available venues appropriate to that demographic group might be displayed on a map, with notations as to appropriate times or other information that might further target the advertisement. For instance, mothers of young children might be most effectively found at Restaurant A on Tuesday at lunch for area play-date meetings at the venue's playground, and Friday nights at Restaurant B, where they gather with their families after soccer games at the nearby fields.

From the point of view of the network operator, the Web Application Server 900 software may be configured to perform a variety of functions including but not limited to one or more of the following:

1) Define “accounts” for users, venues, advertising/promotions customers, patrons (from responses), etc.

2) Track and maintain the health and proper operation of the entire network and affiliated systems;

3) Manage deployment, and status, and history of remotely deployed assets (such as, for instance, Tabletop Display Units 100 and Venue Support Servers 200);

4) Manage scheduling and version and release control for advertising and promotional content as well as associated control metadata. (Before being released for replication through the network, all advertising and promotional content should clear a review and approval process. This may be automated, but is most likely manual, since it will usually involve judgment calls such as appropriateness, legality (a significant concern for alcohol advertising and promotion, since what is allowable can vary significantly according to state and local laws), and quality of proposed advertising and promotional content);

5) Manage and integrate the various databases and file storage resources necessary to support each of the functions available to the network;

6) Generate and/or adjust pricing for advertisements and promotions based on a set of criteria including but not limited to the following:

a. Available capacity;

b. Demand for a particular target market;

c. Value of the target demographic;

d. Specificity of the target (more finely targeted ads might cost more);

7) Manage a market for advertising and promotional capacity in the network, this may be conditionally auction-based, for instance, buyers might buy capacity at price X, but be willing to sell that capacity at price X+Y, or slots representing high-demand demographics might be auctioned to the highest bidder.

8) Collect information from the network as well as advertiser/promoter customers, venue owner/operators, other partners, and external sources to form a knowledge base of related information including but not limited to actual detailed demographics of venues over time, interactive responses and characteristics thereof, effectiveness of varying promotional and advertising approaches, programs, and campaigns (including price/performance and ROI analyses), and other relevant information.

9) Define common data that can be shared by all users, for instance time windows for events that may affect many venues but fall on varying dates, such as Easter or Mother's Day, or large local events such as festivals and conferences.

10) Manage and track billing and payments from advertisers and optionally, payments for revenue sharing with venue owners and operators.

11) Integrate with electronic commerce and payment systems to facilitate and streamline transactions.

The Web Application Server 900 software may also be configured to facilitate, manage and track communications for patron response to advertisements and promotions deployed into the network (as outlined in FIG. 4), both for venue owner/operators and advertising and promotions customers. Interactivity may be provided to “close the loop” on restaurant and bar tabletops advertisements and promotions by either direct or “in-band” response in embodiments in which interactive capabilities of the Tabletop Display Device 100 itself and its associated network are available, or indirectly, though “out-of-band” methods including, but not limited to, text messaging, telephone calls, web site URL hits, e-mails, etc. Note that “interactive” responses may not necessarily require a “live” data connection—for instance, if an advertisement on the Tabletop Display Device 100 urges patrons to register for a contest of some sort, then the patron may register directly on an interactive Tabletop Display Device with the collected data securely forwarded “upstream” at the next replication event rather than immediately as would be possible f live network capabilities were available to the Tabletop Display Device. The interactivity support services of the Web Application Server 900 software may be implemented as illustrated in the examples below, showing the sorts of actions, environments, responses, and data flows present in some envisioned embodiments:

1) The Tabletop Display Device 100 in a restaurant displays a promotional advertisement, for restaurant promotion offering a 50% discount on dessert if the patron responds via a text message. The patron responds via wireless phone SMS text message using a short “tag” (say “sweet”) sent to a text message phone number or “short code” (say “SAMPLE”, which corresponds to 726753). The text message to is received by a remote automated text message receiving system and the contents of the message (the tag “sweet”), along with associated information such as time received, phone number received from, etc. are gleaned from the message and forwarded to the interactive response system (presuming it is different from the receiving system). The interactive response system looks up the appropriate response action, in this case, replying to the patron's cell phone via another text message with a unique code validating the discount, and then logs the appropriate transaction information for later analysis. The response message may also include an opt-in approval request, so the patron might, for example, respond to the dessert code with a or “Yes” message to authorize a once-monthly message about upcoming specials. Response codes may be one-time random or pseudo-random codes to prevent the re-use or prediction of valid response codes. The patron shows or gives this code to, the server to receive the discount on the dessert, and the server may optionally validate the code using a web interface, a printed list of valid codes, or a direct interface to the restaurant's existing order management system. The next week, the restaurant manager is able to log in and track how much revenue was generated by this dessert special, and also now has monthly access through the network to good customers that want a closer relationship with the restaurant.

2) A local car dealer is using the Tabletop Display Devices at a local restaurant to advertise a truck that has been sitting too long in inventory. The advertisement includes a phone number and a web URL from a pool owned by the network provider and specific to this vehicle. Calls to the phone number or visits to the DPI will be immediately and transparently redirected to another appropriate number or DPI of the advertiser's choosing, but the request is logged so that effectiveness an return on investment of the advertisement can be measured. Note that phone calls and/or web sites may also deliver unique codes or other content for discounts, promotions, or tracking purposes.

3) An event management group would like to solicit, attendees to a local event. The advertiser uses the Web Application Server 900 software to identify appropriate venues to target the desired demographic groups at specific “sales-capable” venues in the desired geographic area, and purchases appropriate ad space via the Web Application Server 900 interface, and also chooses the restaurant-bill option to focus on venues that are set up to add third-party items such as tickets to the restaurant bill or check. The advertisements on the Tabletop Display Device 100 feature information about the event, and a call to action: “Buy Tickets Now! Ask your server to add them to your bill.” Patrons may then respond by letting the server know that they would like to purchase tickets to the event, and the server adds the cost of the tickets to the bill and presents the tickets when the bill is settled. The ticket sales process may be documented through the Web Application Server 900 to provide tracking for sales of pre-printed paper tickets, or tickets might, in an alternative embodiment, even be automatically generated and printed on at the restaurant through the system.

4) A third party advertiser is launching a hot new wireless phone and wants to capitalize on the buzz surrounding its new features. The advertiser deploys branding advertisements in purchased slots across the network to deliver the desired number of impressions. Each of these ads has a call to action asking the patron to enter an email address to get updates on availability and a chance to win a free phone at launch. In this case, patrons may enter their e-mail address in a variety of ways: by sending a text message containing their e-mail address, by sending an e-mail message to a special address, by visiting a special web URL, or if the venue has advanced Tabletop Display Devices with interactive features, the patrons may simply enter their email address directly into the device itself, and in all cases, receive a confirmation, in this case perhaps an e-mail saying that they have been entered and will receive a monthly update.

5) A restaurant patron sits down at the table after work with his party and their presence is detected by the Tabletop Display Device, which then starts displaying a set of advertisements featuring drink specials, each of which has “order” button on the screen. The party selects the drinks they want and places their order, which is immediately forwarded and entered into the bar's order entry system. Moments later, the drinks are delivered to their table. A waiter or waitress (who my be carrying a portable display showing the order status of all tables) tells the patrons that the appetizers they have already ordered using the touchscreen interface of the Tabletop Display Device will be ready in another minute or two. Later, when the meal is finished, the Tabletop Display Device is again used to easily split the check and the tip amongst the party at the table—each person is able to select the items he ordered, add a tip, and settle his bill electronically with a card reader built into the Tabletop Display Device, or by leaving the indicated amount of cash on the tabletop for the waiter or waitress.

The executable software code running on Web Application Server 900 may provide functions as described herein and may be implemented as a series of interconnected database applications. (For the purposes of this description, a “database” does not necessarily require the use of a conventional “database engine” or relational database management system, but may be any collection of data arranged in such a way as to facilitate searching and organization this may include not only conventional database records in table or other form, but also files and file systems, object data stores, direct memory access, etc.) For instance, there may be a geographic database to facilitate searches by location, a demographic database to collect, store, and maintain detailed demographic information about each venue, and of course a database or file store for maintaining and staging the actual advertising and promotional content to be replicated through the network for eventual deployment on the Tabletop Display Devices.

### CONCLUSION

Potential benefits of the disclosed invention for the parties involved, principally the restaurant and bar venues, their patrons, the advertiser and promoters (either third-party or those offering venue-relevant products or services such as suppliers of food and beverages), and the network operator(s) may include:

1. Increased sales and margins for restaurants and advertisers,

2. Ability to reach finely targeted demographic audiences for the advertisers,

3. Relevant information delivered to venue patrons from both the venue itself (specials, features and promotions) as well as the advertisers (buy a ticket for the new movie right here with your dinner) or external sources (news, weather, information, etc.)

4. More flexible timing of advertising and campaigns, and even targeting of sub-markets (for instance the breakfast and dinner crowds at a venue may have significantly different demographic profiles.)

5. Faster time to deploy new advertising and promotional campaigns, more frequent updating of campaigns, and more cost-effective modification of those campaigns to improve results based on more immediate feedback and measurements of effectiveness.

6. Lower cost to create and den by new advertisements and promotions for both venue owners and advertisers, leading to the ability cc cost-effectively make incremental improvements to “dial in” on the most effective kinds of messages in particular circumstances.

7. Entertain and inform patrons, and decrease perceived wait time.

8. Frequency of advertisements makes advertisements stand out in patrons minds and allows a last in number of impressions in a single average meal sitting, useful to both restaurants and advertisers.

9. Provide, assured “reach” to the target audience at a particular venue.

10. Allow interactive response to advertisements and promotions using a variety of common mechanisms and methods, many of which may already familiar to most patrons.

11. Easily track and measure the effectiveness, response types and rates, and return on investment for various advertisements, specials and promotions, for both advertisers and restaurants

12. Streamline interactions between venues and patrons, for instance by presenting the menu on the Tabletop Display Device, and If interactivity is available even placing orders directly.

13. Allow creation of a “tabletop digital display market” that can be used to price, target, buy, sell or trade advertising and promotional capacity.

There are many possible ways to implement the invention described here, and the specific implementations mentioned are not intended to limit the scope of the invention, but simply to illustrate some possible embodiments of the invention. Many minor changes or substitutions of roughly equivalent elements are possible to skilled practitioners but would not significantly alter the focus of the invention as a system designed to effectively deliver targeted advertising and promotions.

1. A system comprising:
a plurality or table-top devices for communicating advertising content associated with an advertiser to patrons of a business establishment, wherein each of the plurality of table-top devices includes a data interface configured to communicate with one or more personal electronic devices of the patrons, a data storage configured to store content data that defines the advertising or promotional content, and a control unit configured to access the content data in the data storage and control communication of the advertising content via the data interface,
a server subsystem configured to allow user selection of the content data and to facilitate distribution of the content data to the plurality of table-top display devices;
wherein distribution of the advertising content to the plurality of table-top display devices is at least partially managed by the advertiser.

2. The system of claim 1 wherein the data interface provides wireless communication to the one or more personal electronic devices.

3. The system of claim 1 wherein at least some of the table-top devices further include a display screen for configured to display the advertising content and wherein the control unit is further configured to display the advertising content on the display screen.

4. The system of claim 1 wherein the display screen is a touchscreen display.

5. The system of claim 1, wherein the server subsystem monitors a performance of interactive feedback to the advertising Content.

6. The system of claim 5, wherein the interactive feedback monitored by the server subsystem comprises direct interactivity via at least one of the plurality of table-top display devices.

7. The system of claim 5, wherein the interactive feedback monitored by the server subsystem comprises indirect interactivity via at least one of text messages, electronic mail, phone calls, or websites.
